(19) United States
(12) Patent Application Publication
(10) Pub. No.: US 2026/0029944 A1
(43) Pub. Date: Jan. 29, 2026

(54) MEMORY DEFRAGMENTATION IN PROGRAMMABLE INTEGRATED CIRCUIT DEVICES

(71) Applicant: Xilinx, Inc., San Jose, CA (US)

(72) Inventors: Chaithanya Dudha, San Jose, CA (US); Pradip Kar, San Jose, CA (US); Nithin Kumar Guggilla, Hyderabad (IN)

(73) Assignee: Xilinx, Inc., San Jose, CA (US)

(21) Appl. No.: 18/784,251

(22) Filed: Jul. 25, 2024

(51) Int. Cl. G06F 3/06

(52) U.S. Cl. CPC G06F 3/0646; G06F 3/0604; G06F 3/0676; G06F 2206/1004

(57) ABSTRACT

Memory defragmentation in a programmable integrated circuit (IC) device includes detecting, by computer hardware, instances of memory of a circuit design that are fragment memory instances. A group including a plurality of the fragment memory instances that are compatible with memory merger criteria are generated by the computer hardware. A composite memory is generated by the computer hardware by merging the fragment memory instances of the group. The fragment memory instances of the group are replaced with the composite memory.

### TECHNICAL FIELD

This disclosure relates to programmable integrated circuit (IC) devices and, more particularly, to memory defragmentation in a programmable IC device.

### BACKGROUND

Programmable integrated circuit (IC) devices are manufactured to include predefined circuit blocks referred to as primitives that may be used to implement a user's circuit design. As an example, a programmable IC device may include a variety of different types of predefined memory circuit blocks referred to as memory primitives. The memory primitive, for example, may include a random-access memory (RAM) circuit and access circuitry such as port(s) that support read operations and/or write operations to the RAM circuit. The access circuitry may be connected to other circuits and/or systems in the programmable IC device to implement the user's circuit design.

Because memory requires significant area and is costly to implement, programmable IC devices have limited on-chip memory resources. The lack of on-chip memory can be a limiting factor in the adoption of programmable IC devices in certain applications and/or industries. To meet performance, size, and power requirements, programmable IC devices must make efficient use of the on-chip memory that is available. Having adequate on-chip memory is a concern for a variety of different applications and/or use cases involving programmable IC devices including, for example, data center applications where the computations performed often require wider and deeper on-chip memories.

In many cases, circuit designs are implemented with fragmented memory structures. That is, the instances of memory within the circuit design may be specified in a fragmented manner. Logical fragmentation often results in physical fragmentation of memory across the programmable IC in the physically realized circuit design. This logical and physical memory fragmentation means that memory primitives of the programmable IC device are used inefficiently.

### SUMMARY

In one or more embodiments, a method includes detecting, by computer hardware, memory instances of a circuit design that are fragment memory instances. The method includes generating, by the computer hardware, a group including a plurality of the fragment memory instances that are compatible with memory merger criteria. The method includes generating, by the computer hardware, a composite memory by merging the fragment memory instances of the group. The method includes replacing, by the computer hardware and within the circuit design, the fragment memory instances of the group with the composite memory.

In one or more embodiments, a system includes a hardware processor capable of executing operations. The operations include detecting memory instances of a circuit design that are fragment memory instances. The operations include generating a group including a plurality of the fragment memory instances that are compatible with memory merger criteria. The operations include generating a composite memory by combining the fragment memory instances of the group. The operations include replacing, within the circuit design, the fragment memory instances of the group with the composite memory.

In one or more embodiments, a computer program product includes one or more computer readable storage mediums having program instructions embodied therewith. The program instructions are executable by computer hardware, e.g., a hardware processor, to cause the computer hardware to execute operations. The operations include detecting memory instances of a circuit design that are fragment memory instances. The operations include generating a group including a plurality of the fragment memory instances that are compatible with memory merger criteria. The operations include generating a composite memory by combining the fragment memory instances of the group. The operations include replacing, within the circuit design, the memory instances of the group with the composite memory.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 is a flow chart illustrating a method of defragmenting memory of a programmable integrated circuit (IC) device in accordance with one or more embodiments of the disclosed technology.

FIGS. 2A and 2B, taken collectively, illustrate an example of a horizontal merger operation in accordance with one or more embodiments of the disclosed technology.

FIGS. 3A and 3B, taken collectively, illustrate an example of a vertical merger operation in accordance with one or more embodiments of the disclosed technology.

FIG. 4 is a flow chart illustrating a method of defragmenting memory of a programmable IC device in accordance with one or more embodiments of the disclosed technology.

FIGS. 5A and 5B, taken collectively, illustrate another example of a horizontal merger operation in accordance with one or more embodiments of the disclosed technology.

FIGS. 6A and 6B, taken collectively, illustrate another example of a vertical merger operation in accordance with one or more embodiments of the disclosed technology.

FIG. 7 illustrates an example implementation of a data processing system for use with the inventive arrangements described within this disclosure.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to programmable integrated circuit (IC) devices and, more particularly, to memory defragmentation in a programmable IC device. In many cases, circuit designs are specified with fragmented or highly fragmented memory. One reason is that as a circuit design is created, a circuit designer often specifies the memory needed for particular functions or circuit blocks on an individual basis. That is, if a portion of data is to be stored, the circuit designer specifies a small logical memory for storing that data. Another reason is that circuit designers often work or operate in different design groups, each being responsible for a different portion of the larger circuit design. As such, each design group often creates the logical memories needed for their respective portion of the circuit design without regard to the logical memories being created by other design groups.

During the circuit development process, a higher-level view of the memory architecture is not undertaken or considered. This logical fragmentation of memory in the circuit design leads to physical fragmentation of memory in the programmable IC device in which the circuit design is physically realized. This physical fragmentation means that many of these smaller, fragmented memories do not fully utilize the underlying memory primitive(s) of the programmable IC device.

The inventive arrangements improve the efficiency of on-chip memory usage in an IC device by logically defragmenting memory of a circuit design. Individual instances of memory may be combined, or merged, in certain circumstances into a larger logical memory referred to herein as a “composite memory.” Within the circuit design, the composite memory replaces the individual instances of memory that were combined or merged to form the composite memory.

The circuit design implementation tools are capable of operating on the circuit design as modified to include the composite memory (or composite memories as the case may be). The implementation tools perform operations such as synthesis, placement, and routing. The implementation tools implement the composite memory using fewer on-chip memory resources than would have been the case had the composite memory not replaced the smaller, fragmented memories that were merged. In other words, the circuit design with the composite memory therein in place of the fragmented memories, as physically realized within the programmable IC device, requires fewer memory primitives of the programmable IC device. Of the memory primitives that are used, such resources are more fully utilized (e.g., have less unused space).

By reducing the on-chip memory resources required to physically realize the circuit design within the programmable IC device, the Quality-of-Result (QoR) achieved in the circuit design as physically realized within the programmable IC device is improved. In some cases, improved QoR may be realized in that the implementation tools are able to successfully place and/or route a circuit design that, without the creation a composite memory in place of the fragmented memories, would have been infeasible to place and/or route (e.g., placement and/or routing may have failed). In other cases, improved QoR may be realized in that the use of fewer on-chip memory resources of the programmable IC device leads to reduced power consumption by the programmable IC device. In still other cases, improved QoR may be realized in that the programmable IC device is able to implement a larger circuit design than would otherwise have been the case.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

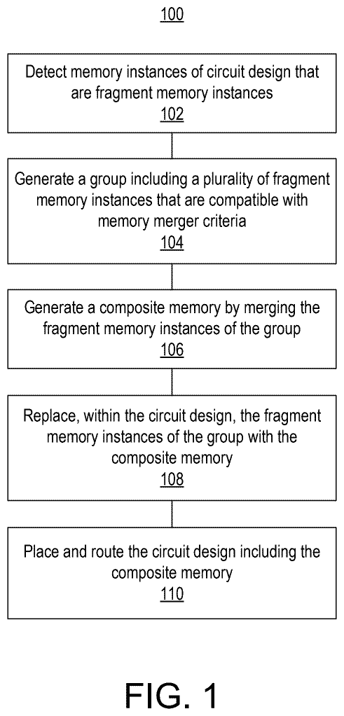

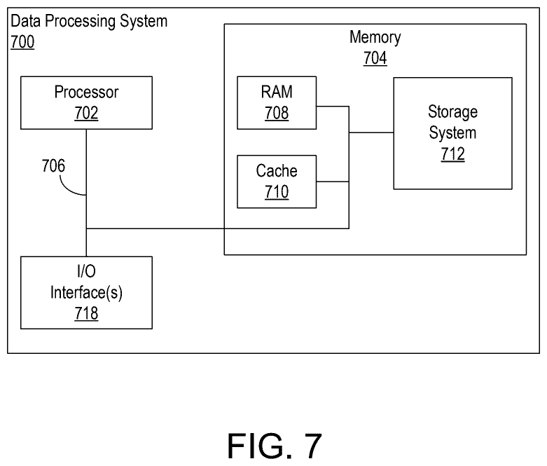

FIG. 1 is a flow chart illustrating a method 100 of defragmenting memory of a programmable IC device in accordance with one or more embodiments of the disclosed technology. Method 100 may be implemented by a computer-based system (system) as a computer-implemented process. The system may be implemented as a data processing system, e.g., a computer, configured to execute an Electronic Design Automation (EDA) tool. An example of a system that is capable of performing the operations of FIG. 1 is described in connection with FIG. 7.

A programmable IC device may include any of a variety of integrated circuit devices having one or more dies (e.g., one or more chiplets) that include programmable circuitry having memory primitives. An example of programmable circuitry is programmable logic. An example of a programmable IC device is a Field Programmable Gate Array (FGPA). Other examples of programmable IC devices include Systems-on-Chip (SoCs) having programmable circuitry including memory primitives and/or a multi-chip module in reference to an electronic system including a plurality of dies or chiplets within a single package. In the case of a multi-chip module, one or more dies or chiplets thereof may include programmable circuitry having memory primitives or be implemented as an FPGA.

Method 100 may begin in a state where the system has received a circuit design for processing. The system may open the circuit design and/or load the circuit design, at least partially, into memory for processing. The circuit design may be a user-specified circuit design. In one or more embodiments, the circuit design is specified as a Register Transfer Level (RTL) description and may be specified in any of a variety of different hardware description languages.

In block 102, the system is capable of detecting memory instances of the circuit design that are fragment memory instances. The term “target programmable IC device” means a particular model or part number of a programmable IC device in which the circuit design is to be physically realized. Within this disclosure, a “memory instance” or an “instance of memory” is a logical memory. The logical memory is defined in the circuit design using RTL. As defined within this disclosure, the term “fragment memory instance” is a memory instance having a size defined in the circuit design that does not fully utilize one or more memory primitives of a target programmable integrated circuit device. For example, a fragment memory instance has a size defined in the circuit design that does not fully utilize available space (e.g., memory) of a single memory primitive available on the target programmable IC device or does not fully utilize available memory space of two or more, e.g., an array, of memory primitives available on the target programmable IC device that are needed to accommodate the size of the memory instance. A fragment memory instance is a memory instance that, when implemented or mapped onto a single memory primitive does not require the entirety of memory of the memory primitive (e.g., memory of the memory primitive is unused) or when implemented or mapped onto a plurality of memory primitives does not require the entirety of memory of each memory primitive of the plurality of memory primitives (e.g., memory of at least one memory primitive of the plurality of memory primitives is unused).

For example, a memory instance of the circuit design having a size of 1 KB may be implemented using a memory primitive on the target programmable IC device. In the case where the smallest memory primitive is 36 KB in size (e.g., capable of storing 36 KB of data), the size of the memory instance is less than the size of the smallest memory primitive and is said to “partially occupy a memory primitive.” As another example, a memory instance defined in the circuit design with a size of 35 KB is less than a 36 KB memory primitive available on the target programmable IC device. Both cases are examples of fragment memory instances where the memory instance partially occupies a memory primitive of the target programmable IC device.

In another example, a memory instance defined in the circuit design with a size of 37 KB is greater than a 36 KB memory primitive available on the target programmable IC device. The additional 1 KB of the memory instance beyond the 36 KB requires an additional memory primitive of the target programmable IC device, but does not fit evenly within any other memory primitive available on the target programmable IC device leaving empty or unused space in an additional memory primitive that is needed. The 37 KB memory instance is another example of a memory instance that partially occupies a memory primitive and is thereby considered a fragment memory primitive.

In another example, consider a memory instance having a size of 36 KB that may be implemented using a 36 KB memory primitive or a memory instance having a size of 72 KB that may be implemented using two 36 KB memory primitives. Both of these cases fully occupy each memory primitive of the target programmable IC used to implement the memory instance. As such, neither memory instance is said to be a fragment memory instance as in each case the memory primitive(s) used to implement the respective memory instance are fully occupied (e.g., fully utilized and contain no empty space).

In this regard, the system is capable of detecting memory instances of the circuit design that are fragment memory instances by comparing the size each memory instance with available memory primitives of the target programmable IC device (e.g., different combinations and/or permutations of memory primitives of same and/or different sizes) to detect memory instances that may not (e.g., cannot) be implemented using one or more available memory primitives of the target programmable IC device and fully utilize the capacity of each such memory primitive used to implement the respective memory instance. In response to determining that a memory instance has a size that may not (e.g., cannot) be implemented using one or more memory primitives of the target programmable IC device in which the entire capacity of each such memory primitive is utilized, the memory instance considered a fragment memory instance and is selected for processing (e.g., detected in block 102).

In block 104, the system is capable of generating a group that includes a plurality of the fragment memory instances that are compatible with memory merger criteria. In one or more embodiments, the system is capable of comparing attributes of each fragment memory instance of the group with predetermined merger criteria. In one aspect, the memory merger criteria specify validation rules for merging logical memories of the circuit design in at least one dimension. The validation rules specify conditions to be met by the attributes of the fragment memory instances to be merged in a given dimension. In response to detecting that a fragment memory instance of the group is incompatible with the memory merger criteria, the system is capable of removing each such fragment memory instance from the group.

The memory merger criteria may specify requirements for performing various types of memory merger operations on the logical memories of a group. The memory merger criteria, for example, may specify requirements for common inputs of the memory instances. The common inputs may include address signals of the memory instances and/or control signals of the memory instances such as read-enable and/or write-enable signals. In one or more embodiments, the memory merger criteria may be specified individually on a per dimension basis. For example, fragment memory instances of a circuit design may be merged in one or more dimensions. The dimensions include horizontal and vertical. Thus, fragment memory instances may be merged horizontally (e.g., width-wise), vertically (e.g., depth-wise), or both horizontally and vertically as described hereinbelow in greater detail.

In block 106, the system is capable of generating a composite memory by merging the fragment memory instances of the group generated in block 104. The system merges the fragment memory instances that are compatible with the memory merger criteria into a single, larger logical memory referred to herein as a “composite memory.”

In block 108, the system is capable of replacing, within the circuit design, the fragment memory instances of the group (i.e., the fragment memory instances that were merged to form the composite memory) with the composite memory. In replacing the fragment memory instances of the group with the composite memory, the system generates a modified version of the circuit design (e.g., a “modified circuit design).

In block 110, the system is capable of placing and routing the circuit design as modified to include the composite memory. The modified circuit design, for example, is placed and routed to comply with any implementation directives relating to operating frequency requirements, area requirements, or the like given the target programmable IC device. Further, it should be appreciated that each different type and/or model of target programmable IC device may include particular and/or different memory primitives. The placement and/or routing of a circuit design will therefore depend also on the memory primitives that are available given any requirements specified as directives.

The example of FIG. 1 is illustrative that in cases where memory of a circuit design is fragmented as many, smaller memory instances, conventional systems have interpreted the fragmentation as intent on the part of the circuit designers to use separate memory primitive(s) for each memory instance. This results in physical fragmentation of memory of the programmable IC device in which, in the worst case, each memory instance is implemented using a separate memory primitive (or a plurality of memory primitives distinct from the memory primitives used to implement other logical memories).

By combining fragment memory instances that are deemed compatible into a single, and larger logical memory referred to as a composite memory, the system is able to implement the composite memory using fewer memory primitives. Not only may fewer memory primitives be used to physically realize the circuit design in the target programmable IC device, but of those memory primitives that are used, each or many will be utilized to a greater degree (e.g., will store more data). The need for fewer memory primitives often allows the implementation tools to perform operations such as placement and routing in less runtime, but also achieve a higher QoR given there is less competition for memory primitives and routing resources. Within this disclosure, it should be appreciated that the composite memory is functionally equivalent within the circuit design to the plurality of fragment memory instances merged and replaced by the composite memory.

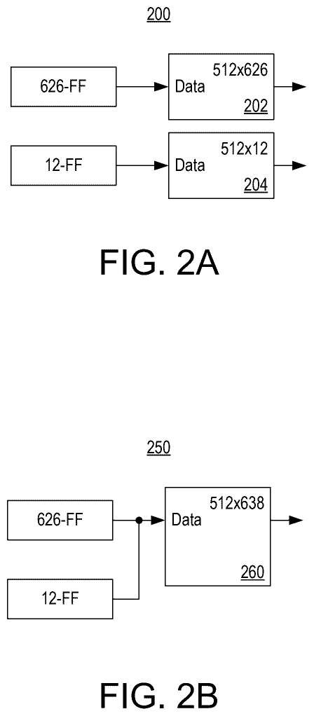

FIGS. 2A and 2B, taken collectively, illustrate an example of a horizontal merger operation in accordance with one or more embodiments of the disclosed technology. FIGS. 2A and 2B may be collectively referred to as FIG. 2. A horizontal merger operation, as performed by the system, merges several fragment memory instances that share common address and control signals, but have disjoint data write and disjoint data read. This condition is often detected in circuit designs that use certain hardware description language structures such as the System Verilog Struct or the VHDL Records used to model several memories. In general, horizontal merger refers to the merger, or joining together, of several “strips” of fragment memory instances horizontally.

In the example of FIG. 2A, a circuit design 200 (or portion of a circuit design denoted as 200) is illustrated. Circuit design 200 includes two fragment memory instances illustrated as memory instance 202 and memory instance 204. Memory instance 202 has an aspect ratio of 512×626. The aspect ratio of a memory instance is the (depth of the memory instance in entries) by (e.g., x) the width of the memory in bits. Thus, memory instance 202 is 512 entries deep and has a width of 626 bits. The aspect ratio of memory instance 204 is 512×12.

In the example of FIG. 2A, memory instances 202 and 204 are controlled by or have same write-enable logic. Thus, both memory instances 202 and 204 are written at the same time or in response to same write-enable signals. In the example, the address used to write data and the data written to memory instances 202 and 204 is common, though not identical. Having an address in common but not identical means that the address used by a first memory instance is specified using more bits than the address of the second memory instance and the address of the first memory instance includes one or more or all address bits of the address of the second memory instance. Further, in the example of FIG. 2A, data is fetched from memory instances 202 and 204 simultaneously.

In the example of FIG. 2B, the system has combined memory instance 202 and memory instance 204 in circuit design 200 to generate a modified version of circuit design 200 illustrated as circuit design 250. In circuit design 250, memory instance 202 and memory instance 204 have been merged to generate composite memory 260. Composite memory 260 is functionally equivalent to memory instances 202 and 204 in circuit design 200. As illustrated, composite memory 260 has an aspect ratio of 512×638. The depth is unchanged relative to fragment memory instances 202 and 204. The width of composite memory 260, however, is the sum of the widths of memory instances 202 and 204. Circuit design 250 of FIG. 2B may be physically realized in the target programmable IC device using 9 RAMB36 memory primitives as opposed to 9.5 RAMB36 memory primitives required to implement circuit design 200 of FIG. 2A.

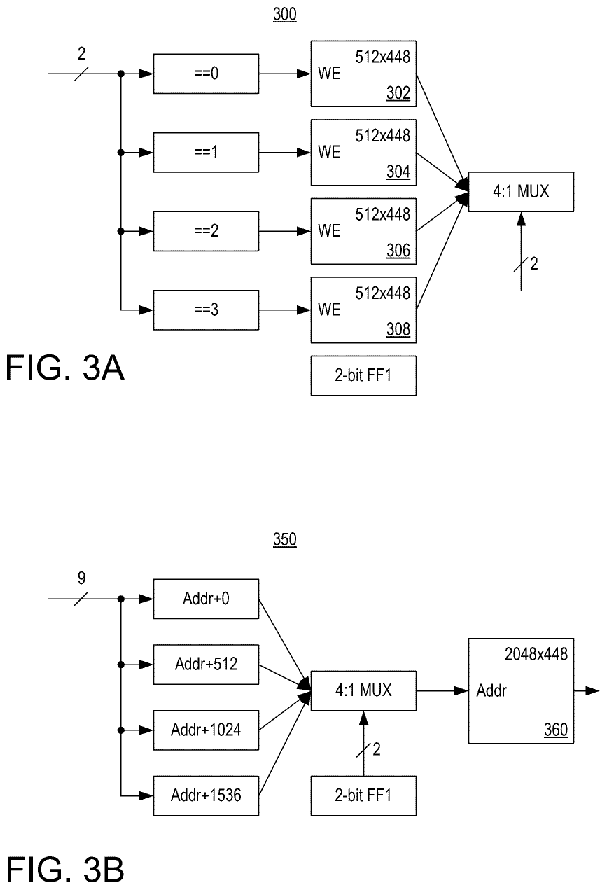

FIGS. 3A and 3B, taken collectively, illustrate an example of a vertical merger operation in accordance with one or more embodiments of the disclosed technology. FIGS. 3A and 3B may be collectively referred to as FIG. 3.

A vertical merger operation merges several fragment memory instances having common input write data and common addressing, but different control signals and different output. The number of control signals ultimately used to implement and/or control the composite memory may be reduced relative to the number of control signals used for the fragmented memory instances being combined. Similarly, the output circuitry may be reduced for the composite memory relative to the fragmented memory instances being combined. A vertical merger operation may be considered the same or similar to stacking memories vertically accompanied by address space transformations.

In the example of FIG. 3A, a circuit design 300 (or portion of a circuit design denoted as 300) is illustrated. Circuit design 300 includes multiple fragment memory instances 302, 304, 306, and 308. Each of memory instances 302, 304, 306, and 308 is specified as having a depth of 512 entries and a width of 448 bits (e.g., an aspect ratio of 512×448). In the example, memory instances 302, 304, 306, and 308 are controlled by different write-enable logic (e.g., different write-enable signals). The address signals and data signals provided to each of memory instances 302, 304, 306, and 308 are the same.

Data fetched from memory instances 302, 304, 306, and 308 are selected by the 4:1 multiplexer based on the 2-bit selection signal provided thereto. The selection signal provided to the 4:1 multiplexer is operative as a read-enable signal ensuring that data is output from only one of memory instances 302, 304, 306, and 308 at a time. Further, data is written to only one of memory instances 302, 304, 306, and 308 at a time as a result of the write-enable signal provided to each memory instance.

In the example of FIG. 3B, the system has modified circuit design 300 to generate a modified version thereof shown as circuit design 350. In circuit design 350, the four memory instances 302, 304, 306, and 308 have been merged into composite memory 360. Composite memory 360 has an aspect ratio of 2048×448. Thus, the system has combined memory instances 302, 304, 306, and 308 into the single, larger composite memory 360. The depth of composite memory 360 is the sum of the depths of memory instances 302, 304, 306, and 308 that were merged. The system updates the address generation logic to generate addresses so that data is stored in the correct address or entry in the larger composite memory 360.

In the example of FIG. 3B, a 2-bit select signal provided to the 4:1 multiplexer is used to choose the particular address logic block from which to pass an address. The 4:1 multiplexer further is capable of concatenating the 9-bit address with the 2-bit select signal to generate an 11-bit address signal provided to composite memory 360. The 2-bit select signal provided to the 4:1 multiplexer is used as the Most-Significant Bits (MSBs) of the 11-bit address provided to the composite memory 360 and is used for write-enable decoding.

In the example of FIG. 3, memory instances may be configured to operate as simple dual port memories or as true dual port memories. The reduction in the number of memory primitives used by way of the merging operation of FIG. 3 will vary depending on the configuration of the memory instances as simple dual port or as true dual port. For purposes of illustration, a RAMB36 memory primitive is used.

In the case where a simple dual port memory configuration is specified by the circuit design, a RAMB36 provides up to 72 bits of width and 1k depth. To achieve the 448 bit width, each of the 4 smaller memory instances 302, 304, 306, and 308 requires 448/72=6.5 RAMB36s. This results in the implementation of FIG. 3A requiring a total of 26 RAMB36s. When memory instances 302, 304, 306, and 308 are combined as illustrated in FIG. 3B, the system is capable of physically realizing composite memory 360 using only 25 RAMB36s.

In the case where a true dual port memory configuration is specified by the circuit design, there is a greater reduction in the number of memory primitives. In a true dual port configuration, each RAMB36 has a maximum width of 36 bits with a 1k depth. Thus, each memory instance 302, 304, 306, and 308 requires 448/36=12.5 RAMB36s. This means that implementation of FIG. 3A requires a total of 50 RAMB36s. When memory instances 302, 304, 306, and 306 are combined as illustrated in FIG. 3B, a deeper aspect ratio of 2k×18 which is available for the RAMB36 may be used. In consequence, FIG. 3B may be implemented using only 448/18=25 RAMB36s.

In one or more other embodiments, the creation of a larger composite memory also allows the system to utilize a memory primitive having a larger capacity. Thus, the composite memory of FIG. 3B may be implemented using the larger capacity memory primitive (which reduces the number of memory primitives needed) compared to implementing the individual memory instances of FIG. 3A with a larger number of smaller capacity memory primitives. In addition, it may be observed that the usage of multiplexer circuitry, whether dedicated multiplexer primitives or multiplexers formed of programmable logic, in the target programmable IC device is reduced. The 4:1 multiplexer in FIG. 3A receives 4 different 448-bit inputs where the width of each input corresponds to the data width of the memory instance. The 4:1 multiplexer in FIG. 3B, by comparison, receives 4 different 9-bit inputs where the width of each input corresponds to the width of the address. As may be seen, the amount of multiplexer circuitry used in FIG. 3B is significantly less than that needed for FIG. 3A.

It should be appreciated that the particular memory primitive used is not intended as a limitation of the inventive arrangements. Different target programmable IC devices will have different memory primitives with different modes and different available aspect ratios. As illustrated above, a given memory primitive may be configurable, or programmed, to use a particular one of a plurality of different aspect ratios. The implementation tools are capable of selecting a particular aspect ratio for such configurable memory primitives. The inventive arrangements, by merging fragmented memories into the composite memory as described, provide the implementation tools with greater flexibility in selecting primitive(s) and also in choosing the particular aspect ratio so as to reduce the amount of on-chip memory resources used to implement the circuit design.

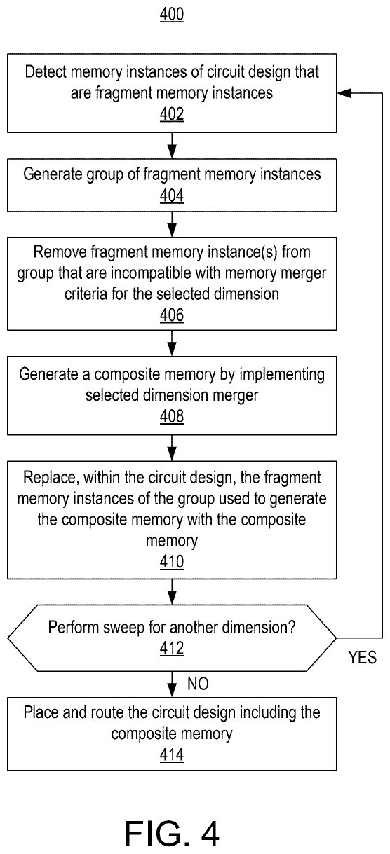

FIG. 4 is a flow chart illustrating a method 400 of defragmenting memory of a programmable IC device in accordance with one or more embodiments of the disclosed technology. Method 400 may be implemented using a computer-based system (system) as a computer-implemented process. The system may be implemented as a data processing system, e.g., a computer, configured to execute an EDA tool. An example of a system that is capable of performing the operations of FIG. 4 is described in connection with FIG. 7.

In one or more embodiments, the example of FIG. 4 may be implemented as an alternative or more detailed version of the example of FIG. 1. In the discussion below, it should be appreciated that the particular memory merger criteria discussed for the horizontal merger operation and for the vertical merger operation (e.g., each different dimension) may be used as the memory merger criteria in the example of FIG. 1 for the corresponding merger operation or dimension performed.

Method 400 may implement a one-dimensional sweep or a two-dimensional sweep for a defragmentation process as described below. Method 400 may begin in a state in which a circuit design has been received by the system as input for processing. In one or more embodiments, the system is capable of transforming the circuit design into a directed flow graph for purposes of analyzing and/or traversing the circuit design to perform the various operations described hereinbelow.

In block 402, the system is capable of detecting memory instances of a circuit design that are fragment memory instances. In block 404, the system is capable of generating a group of fragment memory instances. The group includes two or more fragment memory instances as detected in block 402. For purposes of illustration and ease of discussion, method 400 is described in the context of processing one group. It should be appreciated that more than one group of memory instances may be formed. In that case, other operations illustrated in FIG. 4 may be performed for each group, e.g., iteratively to process each group, such that the operations described in blocks 406, 408, and/or 410 are performed on a per-group basis.

In one or more embodiments, the group of fragment memory instances may be generated using a clustering technique. The grouping may use a cost function to determine whether to add a given memory instance to a group. The fragment memory instances in a same group, however, may or may not be mergeable. That is, the criteria, e.g., the cost function, used to generate groups may allow one or more fragment memory instances into a group that are not mergeable with other fragment memory instances within that group. The generation of groups may be used as an alternative and less computationally intensive technique than comparing each pair of fragment memory instances of the circuit design to ascertain those that are mergeable.

In one or more embodiments, the criteria used to generate the group of fragment memory instances is the number of input nets shared by the memory instances. Fragment memory instances that are logically mergeable will have a significant number of shared input nets. The system is capable of including two or more fragment memory instances in a same group in response to detecting that the fragment memory instances have at least a minimum number of shared or same input nets. The particular number of shared nets used as the minimum for determining that a fragment memory instance may be included in a same group with another fragment memory instance may be the same or may be different when considering a horizontal merger operation and a vertical merger operation.

Two or more memory instances have shared input nets when the memory instances have a same or a common address bus. The term “shared” also includes those nets considered to be equivalent. For example, when combining fragment memory instances across different hierarchies of a circuit design, “shared nets” includes equivalent nets. Equivalent nets are nets with a same driver even if such nets are outside of the hierarchy.

In one or more embodiments, those memory instances that occupy at least a minimum percentage of the underlying memory primitive(s) may be excluded from detection in block 402 and, as such, would not be added or included in a group. That is, in one or more other embodiments, the determination of whether a memory primitive is a fragment memory primitive may use a percentage of occupation of each memory primitive rather than 100% utilization. For example, if the minimum percentage is set to a value of 95%, for purposes of illustration, a memory instance sized to use 95% or more of the available memory bits of the underlying memory primitives will not be detected in block 402 and will not be added to a group. A memory instance that uses 100% of a memory primitive that is 4k in depth and 9-bits in width is not considered a fragment memory primitive. By comparison, a memory primitive that uses 94% of at one or more memory primitives will be considered a fragment memory primitive that is detected in block 402 and added to a group.

In block 406, the system is capable of performing compatibility checks. For the group (or each group), any fragment memory instance that does not match or meet the memory merger criteria for the selected dimension is removed from the group. Such fragment memory instance(s) are considered “non-mergeable.” In block 406, the system removes those fragment memory instances that are incompatible with memory merger criteria in the selected dimension. The memory merger criteria for the horizontal and vertical dimensions are different. In general, for vertical merger, the data and the addressing are shared, but write-enables are different. For horizontal merger, the data is not shared, but the control signals and addressing are shared.

For purposes of illustration, the selected dimension may be horizontal. As noted, the system compares attributes of the fragment memory instances with the validation rules the memory merger criteria for the horizontal dimension as outlined below. In general, for fragment memory instances of a group to qualify for horizontal merger, the system detects that the fragment memory instances have common address and control signals and different data input.

In the case of horizontal merging, also called “word merging,” the system ensures that each fragment memory instance of the group uses same addressing for read operations and for write operations. The system is also capable of checking that each fragment memory instance of the group has the same control signals. The system is also capable of checking that each fragment memory instance of the group is set to operate in the same mode (e.g., that each fragment memory instance is set to operate as read first, write first, or no change). The system is also capable of ensuring that there is no restriction on incoming data, memory initialization content, or on output latch reset values. In the case of horizontal merging, write-enables of the fragment memory instances of the group may be different as any composite memory to be formed from the fragment memory instances of the group may use ByteWideWriteEnable (BWWE).

In the case where the selected dimension is a second, or vertical, dimension, in block 406 the system removes those fragment memory instances that are incompatible with memory merger criteria in the second, or vertical, dimension. The system is capable of comparing attributes of the fragment memory instances with the validation rules of the memory merger criteria for the vertical dimension as outlined below. In general, to perform vertical merger of fragment memory instances of a group, the write-enable logic and the output logic of each fragment memory instance of the group is analyzed to detect the one or more upper MSBs of each fragment memory instance. The system attempts to extract one or more upper MSB of each fragment memory instance if such bits are common. If the system is capable of performing such operations, the memory instances are vertically mergeable. The address space may be expanded to perform the merger resulting in a composite memory. The system is also capable of checking the logic at the output of each fragment memory instance of the group to detect any multiplexing that may require modification.

In the case of vertical merging, also called “address space merging,” the system ensures that each fragment memory instance of the group has a matching internal read and write address bus. Different fragment memory instances of the group may have different address widths. The fragment memory instances, however, must have at least some common address bits. For example, consider a first memory instance of a group with a 1k depth and a second memory instance of the same group with a 2k depth. The 1k depth of the first memory instance requires 10 bits of address while the 2k depth of the second memory instance requires 11 bits of address. The lower 10 bits of the address of the second memory instance must match the 10 bits of address of the first memory instance to perform vertical merging. The system is capable of deducing the extra 1 bit of address from the read/write control logic of the 1k instance and the 2k instance. Further, the system is capable of checking that each fragment memory instance of the group has same control signals. The system is capable of checking that each fragment memory instance of the group is set to operate in the same mode (e.g., that each is set to operate as read first, write first, or no change).

In the case of vertical merging, the system is also capable of checking for the following additional conditions for the group:
That incoming write data and reset values of for all fragment memory instances of the group match;
That the write control circuit for each fragment memory instance of the group is a function of common chip-enable, write-enable, and the upper few bits of address.
That the read circuit of each fragment memory instance of the group is a function of common chip enable, the upper few bits of read address, and the output of each fragment memory instance of the group.
Check that each fragment memory instance of the group passes an address space contiguity check in which the fragment memory instances of the group must address contiguous memory of the composite memory to be formed. For example, the fragment memory instances of the group form a contiguous address space. An exception is at the start and the end of the composite memory where there may be unused words.

With reference to vertical merging, memory initialization content may be different for different memory instances of the group.

The system may check additional memory merger criteria for memory instances of the group whether performing horizontal merger or vertical merger. For example, since the system is constructing a new composite memory out of several fragment memory instances, each fragment memory instance must obey the rules and control signal limitations of the resultant, composite memory. For example, if composite memory may have only one (e.g., a single) clock, the fragment memory instances of the group must have the same clock.

In the example of FIG. 4, horizontal merging is performed first or prior to vertical merging. In one or more other embodiments, vertical merging may be performed first or prior to horizontal merging. The particular order of merging is not intended to be a limitation of the inventive arrangements. Vertical merging and horizontal merging are independent of one another and may be performed in any order. In one or more other embodiments, only horizontal merging or only vertical merging may be performed. That is, the inventive arrangements may perform the merging operation in a selected and single dimension or in both dimensions (in any order).

Appreciably, as fragment memory instances are merged, the complexity of subsequent merger operations is often reduced. Two fragment memory instances A and B may not be merged in both dimensions due to mutual exclusivity with respect to data sharing. Given a circuit design having fragment memory instances A, B, C, and D, however, it may be the case that A and B may be combined horizontally and C and D may be combined horizontally. If fragment memory instances A and B are combined into a composite memory as memory instance {AB} and fragment memory instances C and D are combined into a composite memory as memory instance {CD}, a subsequent pass for the vertical dimension will determine whether memory instances {AB} and {CD} may be combined vertically into a single composite memory.

In those cases where a fragment memory instance A can be merged with a fragment memory instance B in the horizontal dimension and may be merged with a fragment memory instance C in the vertical dimension, in one or more embodiments, the system is capable of choosing the particular merger operation that provides a maximum resource benefit by estimating resource usage resulting from performing the merger in each of the dimensions. The merger operation resulting in the largest reduction of resource usage may be selected.

In another example, the system is capable of detecting that the circuit design has disjointed fragment memory instances that are controlled by multiple, different write-enables. In response to detecting such a condition, the system is capable of ordering the fragment memory instances controlled by same write-enables adjacent to one another. The ordering described herein may better utilize the BWWE feature of certain RAMB primitives compared to using a random ordering of memory instances with no insight or analysis of the write-enables.

Some memory primitives have a feature that permits the writing of a byte of data independently. The write-enable signals that enable such functionality are referred to as “ByteWideWriteEnables” or “BWWEs.” In cases where the independent write-enables can be combined into a BWWE, several fragment memory instances may be merged to fit within one memory primitive. Consider an example with four fragment memory instances in a group where each fragment memory instance has an aspect ratio of 512×9. Prior to merging, the system may take 4 RAMB18 memory primitives and convert independent write-enables to a BWWE to fit the four fragment memory instances into a single RAMB18 memory primitive. This technique also facilitates using larger memory primitives as opposed to several smaller primitives.

Continuing with the case of vertical merging where multiple groups are being processed, the system is capable of ordering the groups by the address space coverage of each group. This allows the system to iterate over the groups and discover missing sections of address space with less computational effort.

In the case of vertical merging, the system is also capable of generating the following circuit structures for the group:
Generate the write-enable and chip-enable circuitry of the composite memory. If no enables can be deduced, the fragment memory instances may be deemed non-mergeable. As generally known, “chip enable” enables a memory for all operations (e.g., read and write). Write-enable enables the memory for write only operation and may provide finer granularity. For a successful write, both write-enable and chip-enable must be enabled.
Generate the upper m-bits of read/write address for each fragment memory instance from read/write control circuitry. The upper m-bits are also referred to as “external” address bits. The system permits different size external address bits. The combination of external and internal addresses of fragment memory instances must match bitwise because the combined address bits will be used as a global address of the composite memory that is created.

After removing any unmergeable fragment memory instances from the group in block 406, the system merges the remaining memory instances of the group in accordance with block 408. In block 408, the system generates a composite memory by performing memory merger in the selected dimension. In cases where multiple groups exist, the system is capable of performing the merging on a per-group basis with each group resulting in a different “composite memory.” Each composite memory is a logical memory that replaces the constituent fragment memory instances of the circuit design.

In block 408, the system may optionally detect whether there is any requirement for two or more fragment memory instances of the group to be adjacent to one another. In response to detecting that two or more of the fragment memory instances of the group must be adjacent to one another (e.g., by virtue of detecting an implementation tool directive), the system is capable of ordering the fragment memory instances to place those memory instances that must be adjacent next to, or adjacent to, one another.

A resulting composite memory may combine the dimensions, e.g., width or depth as the case may be, and copy any initial memory content (e.g., re-use such content). The system generates new read and/or write address circuitry for the composite memory. In one aspect, the system generates the new read and/or write address circuitry by taking a union of internal and external addresses of each fragment memory instance remaining in the group. The system infers and connects new data and control signals for the composite memory as generated. The system further is capable of removing the fragment memory instances and associated glue logic if applicable.

In block 410, the system is capable of replacing, within the circuit design, the memory instances of the group (e.g., those merged to generate the composite memory) with the composite memory. Any additional circuitry generated as described herein is also included in the circuit design.

In block 412, the system is capable of deciding whether to perform another sweep of the circuit design for the other, or second, dimension. If the first sweep implemented horizontal (vertical) merger, the second sweep may implement vertical (horizontal) merger. In one or more embodiments, whether the system performs only vertical merger, only horizontal merger, horizontal merger followed by vertical merger, or vertical merger followed by horizontal merger may be specified as a preference.

For example, since horizontal merger and vertical merger are independent of one another, the respective operations may be performed sequentially in one pass over the netlist in any order, provided the fragment memory instances are near in logical vicinity meaning that the fragment memory instances being merged are within a same hierarchy of the circuit design or are across hierarchies. For purposes of illustration, to merge fragment memory instances, the peripheral logic of the fragment memory instances is evaluated by the system for equivalency of nets. Such an analysis is only possible when the fragment memory instances are inside a same hierarchy or are disposed in nearby hierarchies that are accessible. For purposes of illustration, consider a case in which two fragment memory instances A and B are disposed in different hierarchies of a large circuit design. The hierarchies are far from one another. Though fragment memory instances A and B may have a common driver, detecting this condition when the hierarchies are not close to one another particularly when the size of the circuit design is large is impractical and sometimes infeasible. In such cases, fragment memory instances A and B do not end up on a same group or in any group at all.

Accordingly, in block 412, to perform another sweep, method 400 loops back to block 402 to continue processing and perform defragmentation using the next or other dimension. If no further defragmentation is to be performed or defragmentation has been performed in both dimensions, method 400 continues to block 414.

In block 414, the system is capable of performing place and route on the circuit design as modified including the composite memory. In one or more embodiments, the system is capable of generating configuration data for the circuit design as placed and routed in block 418. The configuration data, in some embodiments, is a configuration bitstream. The configuration data may be loaded into the target programmable IC device to physically realize the circuit design therein.

The composite memory or memories included in the circuit design is/are ultimately implemented (e.g., physically realized) in the target programmable IC device using fewer memory primitives than the original circuit design having fragmented memory. The processing described may be performed for each group with the circuit design as modified to include the one or more composite memories being functionally equivalent to the original circuit design.

By using fewer memory primitives, e.g., a reduced number compared to the original circuit design having fragmented memory, the programmable IC device consumes less power. Those memory primitives of the programmable IC device that are used are more fully utilized. Place and route tools are better able to perform placement and routing, respectively, owing to the reduced number of primitives that need to be placed and the ability to place components closer to one another (reducing routing congestion).

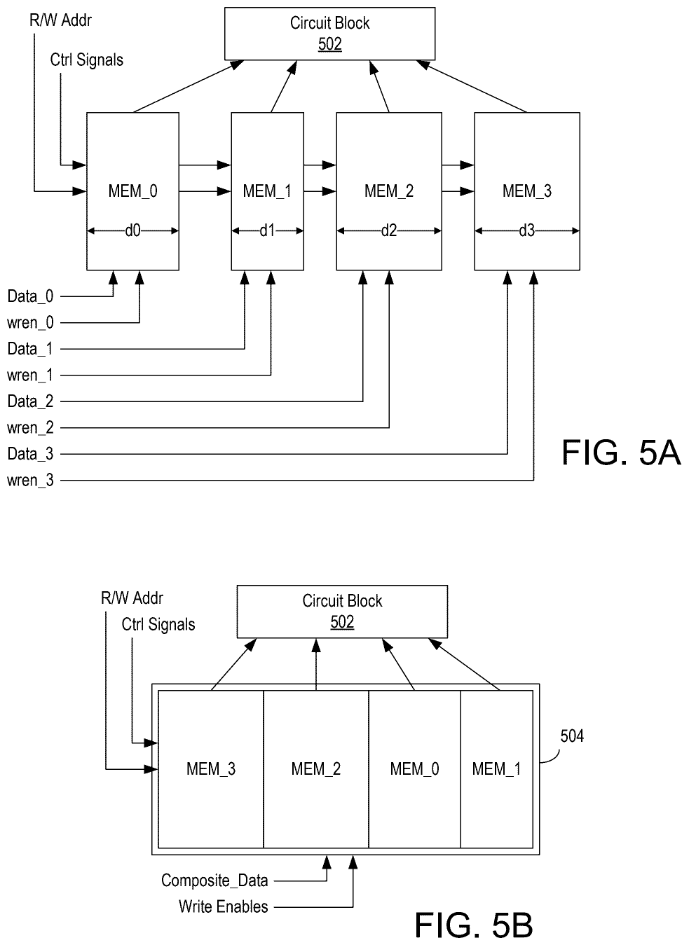

FIGS. 5A and 5B, taken collectively, illustrate an example of a horizontal merger operation in accordance with one or more embodiments of the disclosed technology. FIGS. 5A and 5B may be collectively referred to as FIG. 5.

FIG. 5A illustrates an example in which the system has analyzed a received circuit design and detected memory instances MEM_0, MEM_1, MEM_2, and MEM_3 in block 402 as fragment memory instances and included the memory instances in a group in block 404 for processing in the horizontal dimension. In the example, memory instances MEM_0, MEM_1, MEM_2, and MEM_3 may be detected across different hierarchies of the circuit design. As illustrated, each of memory instances MEM_0, MEM_1, MEM_2, and MEM_3 outputs data to circuit block 502, which consumes the data. In the example of FIG. 5A, those memory instances of the group that are not mergeable have been removed by the system.

FIG. 5B illustrates the composite memory 504 formed by merging memory instances MEM_0, MEM_1, MEM_2, and MEM_3. In the example, composite memory 504 is not simply a sum of memory instances MEM_0, MEM_1, MEM_2, and MEM_3. Rather, composite memory 504 is a union of memory instances MEM_0, MEM_1, MEM_2, and MEM_3. In this regard, the width of composite memory 504 may be less than the sum of widths of memory instances MEM_0, MEM_1, MEM_2, and MEM_3. This may occur, for example, in cases where equivalent slices of data are present in multiple ones of memory instances MEM_0, MEM_1, MEM_2, and MEM_3. In such cases, the system is capable of removing any duplicate bit-slices and adjusting the respective slices of data so that each slice abuts (e.g., there is no gap or empty space horizontally in the composite memory generated).

In the example of FIG. 5, the logical memories of composite memory 504 may be reordered. The composite data provided to composite memory 504 may be reordered with the logical memories and concatenated. In the example, the read and write address signals (R/W address) and the control signals (Ctrl signals) are the same for each of memory instances MEM_0, MEM_1, MEM_2, and MEM_3.

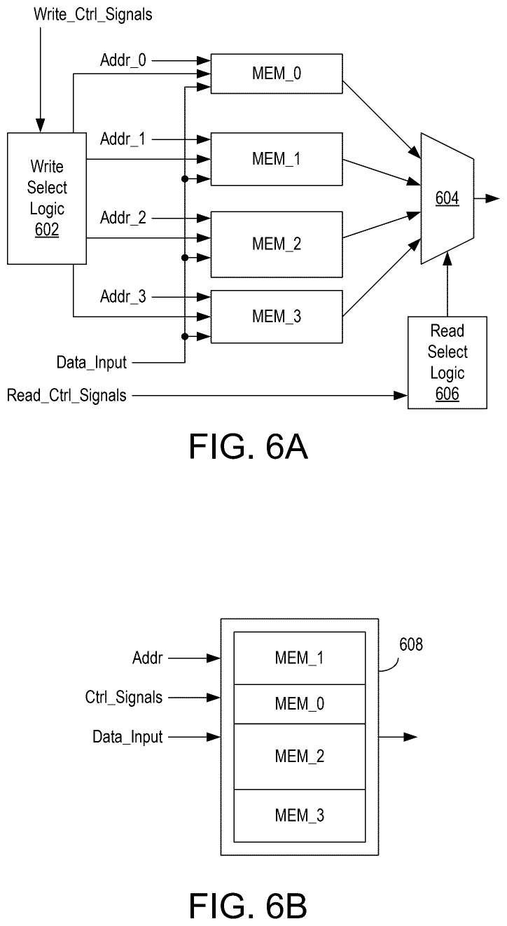

FIGS. 6A and 6B, taken collectively, illustrate an example of a vertical merger operation in accordance with one or more embodiments of the disclosed technology. FIGS. 6A and 6B may be collectively referred to as FIG. 6.

FIG. 6A illustrates an example in which the system has analyzed a received circuit design and detected memory instances MEM_0, MEM_1, MEM_2, and MEM_3 in block 402 as fragment memory instances and included the memory instances in a group in block 404 for processing in the vertical dimension. The vertical merging described herein merges the address spaces of the respective memory instances. In the example, memory instances MEM_0, MEM_1, MEM_2, and MEM_3 may be detected across different hierarchies of the circuit

For example, the system is capable of performing operations such as performing pattern recognition across hierarchies of the circuit design by scanning the input and output cone of the individual memory instances and, for those determined to meet the grouping criteria, add such memory instances to the group. In the example of FIG. 6A, those memory instances of the group that are not mergeable have been removed by the system.

In the example of FIG. 6B, memory instances MEM_0, MEM_1, MEM_2, and MEM_3 are combined vertically into composite memory 608. Address logic (not shown) of FIG. 6A is updated to provide a single address that correctly indexes into composite memory 608 based on the addressing of FIG. 6A and write select logic 602 of FIG. 6A. As the updated address logic accesses a unique address and corresponding memory location in composite memory 608, the output multiplexer 604 and read select logic 606 of FIG. 6A is not required in FIG. 6B.

FIG. 7 illustrates an example implementation of a data processing system 700. As defined herein, the term “data processing system” means one or more hardware systems configured to process data, each hardware system including at least one processor and memory, wherein the processor is programmed with computer-readable instructions that, upon execution, initiate operations. Data processing system 700 can include a processor 702, a memory 704, and a bus 706 that couples various system components including memory 704 to processor 702.

Processor 702 may be implemented as one or more processors. In an example, processor 702 is implemented as a central processing unit (CPU). Processor 702 is an example of a hardware processor that is implemented as one or more circuits capable of carrying out instructions and/or operations embodied as computer readable program instructions. The circuit may be an integrated circuit or embedded in an integrated circuit. Processor 702 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 706 represents one or more of any of a variety of communication bus structures. By way of example, and not limitation, bus 706 may be implemented as a Peripheral Component Interconnect Express (PCIe) bus. Data processing system 700 typically includes a variety of computer system readable media. Such media may include computer-readable volatile and non-volatile media and computer-readable removable and non-removable media.

Memory 704 can include computer-readable media in the form of volatile memory, such as random-access memory (RAM) 708 and/or cache memory 710. Data processing system 700 also can include other removable/non-removable, volatile/non-volatile computer storage media. By way of example, storage system 712 can be provided for reading from and writing to a non-removable, non-volatile magnetic and/or solid-state media (not shown and typically called a “hard drive”), which may be included in storage system 712. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 706 by one or more data media interfaces. Memory 704 is an example of at least one computer program product.

Memory 704 is capable of storing computer-readable program instructions that are executable by processor 702. For example, the computer-readable program instructions can include an operating system, one or more application programs, other program code, and program data. The computer readable program instructions can include/implement the particular operations, functions, and/or executable architectures described within this disclosure. For example, the computer readable program instructions, when executed, may implement an EDA system capable of performing the various operations described herein. The computer readable program instructions, as part of an EDA system, may include instructions that are executable to perform a design flow (e.g., synthesis, placement, and/or routing) on a circuit design or portion thereof so that a circuit design may be physically realized in an IC.

Processor 702, in executing the computer-readable program instructions, is capable of performing the various operations described herein that are attributable to a computer. It should be appreciated that data items used, generated, and/or operated upon by data processing system 700 are functional data structures that impart functionality when employed by data processing system 700. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

Data processing system 700 may include one or more Input/Output (I/O) interfaces 718 communicatively linked to bus 706. I/O interface(s) 718 allow data processing system 700 to communicate with one or more external devices and/or communicate over one or more networks such as a local area network (LAN), a wide area network (WAN), and/or a public network (e.g., the Internet). Examples of I/O interfaces 718 may include, but are not limited to, network cards, modems, network adapters, hardware controllers, etc. Examples of external devices also may include devices that allow a user to interact with data processing system 700 (e.g., a display, a keyboard, and/or a pointing device) and/or other devices such as accelerator card.

Data processing system 700 is only one example implementation. Data processing system 700 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 7 is not intended to suggest any limitation as to the scope of use or functionality of example implementations described herein. Data processing system 700 is an example of computer hardware that is capable of performing the various operations described within this disclosure. In this regard, data processing system 700 may include fewer components than shown or additional components not illustrated in FIG. 7 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, “data processing system” means one or more hardware systems configured to process data, each hardware system including at least one hardware processor programmed to initiate operations and memory.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the inventive arrangements described herein. Within this disclosure, the term “program code” is used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the disclosed technology have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
detecting, by computer hardware, memory instances of a circuit design that are fragment memory instances, wherein each fragment memory instance has a size defined in the circuit design that uses less than one or more memory primitives of a target programmable integrated circuit (IC) device, and wherein the fragment memory instances require a selected amount of the memory primitives of the target programmable IC device for implementation therein;
generating, by the computer hardware, a group including a plurality of the fragment memory instances that are compatible with memory merger criteria;
generating, by the computer hardware, a composite memory by merging the fragment memory instances of the group; and
replacing, by the computer hardware and within the circuit design, the fragment memory instances of the group with the composite memory, wherein the composite memory requires fewer than the selected amount of memory primitives for implementation in the target programmable IC device.

2. The method of claim 1, wherein the generating the group comprises:
comparing attributes of the fragment memory instances with the memory merger criteria; and
removing from the group each fragment memory instance that is incompatible with the memory merger criteria.

3. The method of claim 1, wherein the memory merger criteria specify validation rules for merging logical memories of the circuit design in at least one dimension.

4. The method of claim 3, wherein the at least one dimension is horizontal.

5. The method of claim 4, wherein the validation rules include:
each fragment memory instance of the group uses same addressing for read operations and for write operations; and
each fragment memory instance of the group uses same control signals.

6. The method of claim 3, wherein the at least one dimension is vertical.

7. The method of claim 6, wherein the validation rules include:
each fragment memory instance of the group has a read address bus and a write address bus with a plurality of common address bits; and
the fragment memory instances of the group form a contiguous address space.

8. (canceled)

9. The method of claim 1, further comprising:
placing and routing the circuit design including the composite memory.

10. A system, comprising:
a hardware processor capable of executing operations including:
detecting memory instances of a circuit design that are fragment memory instances, wherein each fragment memory instance has a size defined in the circuit design that uses less than one or more memory primitives of a target programmable integrated circuit (IC) device, and wherein the fragment memory instances require a selected amount of the memory primitives of the target programmable IC device for implementation therein;
generating a group including a plurality of the fragment memory instances that are compatible with memory merger criteria;
generating a composite memory by combining the fragment memory instances of the group; and
replacing, within the circuit design, the fragment memory instances of the group with the composite memory, wherein the composite memory requires fewer than the selected amount of memory primitives for implementation in the target programmable IC device.

11. The system of claim 10, wherein the generating the group comprises:
comparing attributes of the fragment memory instances with the memory merger criteria; and
removing from the group each fragment memory instance that is incompatible with the memory merger criteria.

12. The system of claim 10, wherein the memory merger criteria specify validation rules for merging logical memories of the circuit design in at least one dimension.

13. The system of claim 12, wherein the at least one dimension is horizontal.

14. The system of claim 13, wherein the validation rules include:
each fragment memory instance of the group uses same addressing for read operations and for write operations; and
each fragment memory instance of the group uses same control signals.

15. The system of claim 12, wherein the at least one dimension is vertical.

16. The system of claim 15, wherein the validation rules include:
each fragment memory instance of the group has a read address bus and a write address bus with a plurality of common address bits; and
the fragment memory instances of the group form a contiguous address space.

17. (canceled)

18. The system of claim 10, wherein the hardware processor is capable of executing operations comprising:
placing and routing the circuit design including the composite memory.

19. A computer program product comprising a computer readable storage medium having program instructions embodied therewith, wherein the program instructions are executable by computer hardware to cause the computer hardware to initiate executable operations comprising:
detecting memory instances of a circuit design that are fragment memory instances, wherein each fragment memory instance has a size defined in the circuit design that uses less than one or more memory primitives of a target programmable integrated circuit (IC) device, and wherein the fragment memory instances require a selected amount of the memory primitives of the target programmable IC device for implementation therein;
generating a group including a plurality of the fragment memory instances that are compatible with memory merger criteria;
generating a composite memory by combining the fragment memory instances of the group; and
replacing, within the circuit design, the fragment memory instances of the group with the composite memory, wherein the composite memory requires fewer than the selected amount of memory primitives for implementation in the target programmable IC device.

20. The computer program product of claim 19, wherein the memory merger criteria specify validation rules for merging logical memories of the circuit design in at least one dimension.
